(19) United States
(12) Patent Application Publication
(10) Pub. No.: US 2023/0130199 A1
(43) Pub. Date: Apr. 27, 2023

(54) SEMICONDUCTOR DEVICE SIMULATION SYSTEM AND SEMICONDUCTOR DEVICE SIMULATION METHOD

(71) Applicant: Gwangju Institute of Science and Technology, Gwangju (KR)

(72) Inventor: Sung Min HONG, Gwangju (KR)

(21) Appl. No.: 17/852,191

(22) Filed: Jun. 28, 2022

(30) Foreign Application Priority Data
Oct. 25, 2021 (KR) 10-2021-0142903

(51) Int. Cl. G06F 30/3308

(52) U.S. Cl. CPC G06F 30/3308; G06F 2119/12

(57) ABSTRACT

Provided is a semiconductor device simulation system using region graph. The semiconductor device simulation system comprises: a region graph generation module for generating a region graph using a device structure file of a semiconductor device to be simulated; a device determination module for determining a type of semiconductor device for the region graph using a trained graph artificial neural network; an initial solution generating module for generating an initial solution for a device structure corresponding to the type of semiconductor device; and a semiconductor device simulator for performing semiconductor device simulation using the initial solution. The semiconductor device simulation system accelerates the speed of performing semiconductor device simulation by providing an approximate initial solution to the device structure to a semiconductor device simulator.

### TECHNICAL FIELD

The present invention relates to a semiconductor device simulation system, and more specifically, a semiconductor device simulation system capable of reducing the execution time of semiconductor device simulation by extracting a region graph from a semiconductor device structure file using a supervised-learned artificial neural network, classifying and determining the semiconductor device structure, quickly obtaining an approximate initial solution using a compact model. and providing an initial solution that can accelerate the simulation execution speed to the semiconductor device simulator.

### BACKGROUND ART

The semiconductor device simulation is a technology for predicting the performance of a semiconductor device using a computer program, and is essential to reduce time and cost in the semiconductor device development process. The semiconductor device simulator that performs the semiconductor device simulation is a numerical analysis program that calculates and outputs the electrical characteristics of the semiconductor device by solving the governing equations representing the movement of electrons and holes inside the semiconductor device in a numerical way. The electrical characteristics of the semiconductor device output by the semiconductor device simulator typically include an IV characteristic relationship. Since the governing equations considered in semiconductor device simulation are nonlinear, a complete solution cannot be obtained at once. For this reason, the semiconductor device simulator first assumes an approximate initial solution, and obtains a complete solution by iteratively improving the solution in the direction of reducing the error caused by the assumed initial solution.

In a conventional semiconductor device simulator, semiconductor device structure information and device structure file to be simulated are input by a user, and numerical analysis is performed based on the input data to provide simulation results for the corresponding semiconductor device.

The above-described device structure file is formed of a binary file including names of regions constituting a semiconductor device to be simulated, coordinate information of each vertex for a tetrahedron constituting each region, material information, impurity concentration information, and the like. And the device structure file is created in a unique file format used by each semiconductor device simulator.

In general, the device structure file may be generated using a program called a structure generator or may be generated by a semiconductor process simulator. The structure generator includes a figure drawing program by which a user can draw various geometric figures. A user draws a figure corresponding to a semiconductor device to be simulated using the figure drawing program of the structure generator, and then inputs the figure into the structure generator. The structure generator extracts information on figures input by a user, and automatically creates a device structure file using the extracted information.

Meanwhile, the semiconductor process simulator performs a semiconductor process simulation when process conditions actually will be used for manufacturing are input from a user, and generates and provides a device structure file as a result of the simulation. Although generating a device structure file using the semiconductor process simulator has the disadvantage that the process simulation process takes a lot of time, it has the advantage of being able to generate a device structure file having a device structure and impurity distribution close to reality.

Since the simulation process by the semiconductor device simulator solves a nonlinear equation, it is necessary to know an excellent approximate solution close to the correct answer. However, since it is difficult to know in advance a good approximate solution to the voltage condition that the user wants to know, inevitably, the solution is repeatedly obtained while increasing the voltage step-by-step from the initial setting value. Therefore, most of the execution time of the semiconductor device simulation is spent calculating the answer of this intermediate process. Although techniques such as using parallel computing are applied to reduce the execution time of semiconductor device simulation, a huge amount of computing resources are required overall.

In order to solve this problem, the present inventor has introduced a neural network into a semiconductor device simulator. Korean Patent Application Laid-Open No. 10-2021-0066545, a prior patent of the present inventor, is an “electronic device, method, and computer-readable medium for simulation of semiconductor devices”, and uses an artificial neural network to provide an initial solution required for simulation of semiconductor devices. It is proposed to obtain a method that can significantly reduce the overall time for performing semiconductor device simulation by obtaining the initial solution efficiently. The prior patent models an artificial neural network by supervised training using the existing simulation results as training data through an artificial neural network training process. In addition, the semiconductor device simulator uses the trained artificial neural network to generate a potential distribution inside the semiconductor device to be simulated, and uses the potential distribution generated by the artificial neural network as an approximate solution of the initial solution to find the perfect solution in a short time.

However, in the aforementioned prior patent, an electrostatic potential given in a matrix form for various semiconductor device structures is required as training data in a machine training process for generating the initial solution. However, since the semiconductor device has a complicated three-dimensional shape, it is difficult to sample the electrostatic potential in a matrix form. In addition, when the structure of the device is changed even in the same type of device, the prior patent has a problem in that it is difficult to directly apply the trained neural network model.

### DISCLOSURE OF THE INVENTION

In order to solve the above problems, it is an object of the present invention to provide a semiconductor device simulation system which uses a region graph and a graph artificial neural network model to analyze the structure of a semiconductor device without user intervention even for a three-dimensional complex shape. The semiconductor device simulation system not only improves the simulation speed by enabling automatic analysis of the structure of a semiconductor device, but also enables simulation of a deformed structure similar to the trained structure without the additional training process.

In one aspect of the present invention, there is provided a semiconductor device simulation system comprising: a region graph generation module for generating a region graph using a device structure file of a semiconductor device to be simulated; a device determination module for determining a semiconductor device type for the region graph generated by the region graph generating module using a trained graph artificial neural network; an initial solution generating module for generating an initial solution for a device structure corresponding to the type of semiconductor device determined by the device discrimination module; and, a semiconductor device simulator for performing semiconductor device simulation using the initial solution generated by the initial solution generating module, wherein the speed of performing semiconductor device simulation is accelerated by providing an approximate initial solution to the device structure to a semiconductor device simulator.

In the semiconductor device simulation system according to the present invention, preferably the device structure file is generated by a structure generator program or a semiconductor process simulation program.

In the semiconductor device simulation system according to the present invention, preferably the region graph generating module re-divides bulk regions of the device structure file based on constituent and impurity types, expresses each re-divided bulk region and terminals of the device structure file as nodes, expresses a connection relationship between the nodes, and generates an region graph expressed by nodes and connection relationships.

In the semiconductor device simulation system according to the present invention, preferably the semiconductor device simulation system further comprises a graph artificial neural network training module, the graph artificial neural network training module trains in a supervised manner and models a graph artificial neural network using training data consisting of a pair of a region graph and a corresponding semiconductor device type, and the device determination module determines the type of semiconductor device for the region graph using the graph artificial neural network trained in a supervised manner by the graph artificial neural network training module.

In the semiconductor device simulation system according to the present invention, preferably the initial solution generating module comprises a compact model that provides a current-voltage characteristic equation for each semiconductor device structure, and the initial solution generating module obtains a voltage characteristic equation for a semiconductor device structure corresponding to the type of semiconductor device determined by the device discrimination module using the compact model and sets it as an initial solution for the structure.

In the semiconductor device simulation system according to the present invention, preferably in the initial solution generating module, information on the type of semiconductor element determined by the element determination module and the physical quantity for each region is input, the compact model obtains an approximate solution of the current-voltage characteristic for the physical quantity of each region according to the type of semiconductor device input, an initial solution is generated by summing approximate solutions for each region, and the generated initial solution is provided to the semiconductor device simulator.

In another aspect of the present invention, there is provided a semiconductor device simulation method comprising the following steps: (a) generating a region graph using a device structure file of a semiconductor device to be simulated; (b) determining the type of semiconductor device for the region graph using the trained graph artificial neural network; (c) generating an initial solution for a device structure corresponding to the determined type of semiconductor device; and, (d) performing a semiconductor device simulation using the generated initial solution, wherein the semiconductor device simulation is accelerated.

In the semiconductor device simulation method according to the present invention, preferably the device structure file is generated by a structure generator program or a semiconductor process simulation program.

In the semiconductor device simulation method according to the present invention, preferably the step (a) comprises: re-dividing regions of the device structure file based on constituent and impurity types, expressing each re-divided region and terminals of the device structure file as nodes respectively, expressing a connection relationship between the nodes, and generating an region graph expressed by nodes and connection relationships.

In the semiconductor device simulation method according to the present invention, preferably the semiconductor device simulation method further comprises: (e) training a graph artificial neural network, wherein the graph artificial neural network is trained in a supervised manner and modeled using training data consisting of a pair of a region graph and a type of semiconductor device corresponding to the region graph, and in the step (b), the type of semiconductor device for the region graph is determined using the graph artificial neural network trained in a supervised manner.

In the semiconductor device simulation method according to the present invention, preferably the step (c) comprises preparing a compact model that provides a current-voltage characteristic equation for each semiconductor device structure, and in the step (c), a voltage characteristic equation for a semiconductor device structure corresponding to the type of semiconductor device determined in step (b) is obtained using the compact model and set as an initial solution for the structure.

In the semiconductor device simulation system according to the present invention having the above-described structure, the semiconductor device structure is determined using the artificial neural network model trained in a supervised manner, and an approximate initial solution can be quickly obtained using the compact model.

In addition, the initial solution generating module of the semiconductor device simulation system according to the present invention having the above structure can provide an initial solution capable of accelerating the simulation execution speed to the semiconductor device simulator, and thereby the execution time of the semiconductor device simulation can be shortened several times to hundreds of times.

In addition, the semiconductor device simulation system according to the present invention can determine the semiconductor device structure without user intervention by generating a region graph from the device structure file and discriminating the semiconductor device structure using the region graph and the graph artificial neural network. The semiconductor device simulation system according to the prior art was able to simulate only the semiconductor device structures learned in advance by using a neural network model. However, the semiconductor device simulation system according to the present invention can determine the semiconductor device structure without user intervention and obtain an approximate initial solution corresponding to the determined semiconductor device structure. Accordingly, the system according to the present invention can be applied not only to the learned structure but also to a deformed structure similar to the learned structure without additional learning, and as a result, practicality is greatly increased.

### BRIEF DESCRIPTION OF THE DRAWINGS

FIG. 1 is a block diagram showing the overall semiconductor device simulation system according to a preferred embodiment of the present invention.

FIG. 2 is a flowchart illustrating a process of simulating a semiconductor device using the semiconductor device simulation system according to the present invention.

FIG. 3A is a schematic diagram exemplarily illustrating a semiconductor device structure for a PN diode input to generate a device structure file, and FIG. 3B is a region graph for the PN diode in the semiconductor device simulation system according to the present invention.

FIG. 4A is a schematic diagram exemplarily showing a semiconductor device structure for a double gate MOSFET input to generate a device structure file, and FIG. 4B is a region graph for the double gate MOSFET in the semiconductor device simulation system according to the present invention.

### DETAILED DESCRIPTION OF THE INVENTION

Hereinafter, a semiconductor device simulation system and a semiconductor device simulation method in the system according to a preferred embodiment of the present invention will be described in detail with reference to the accompanying drawings.

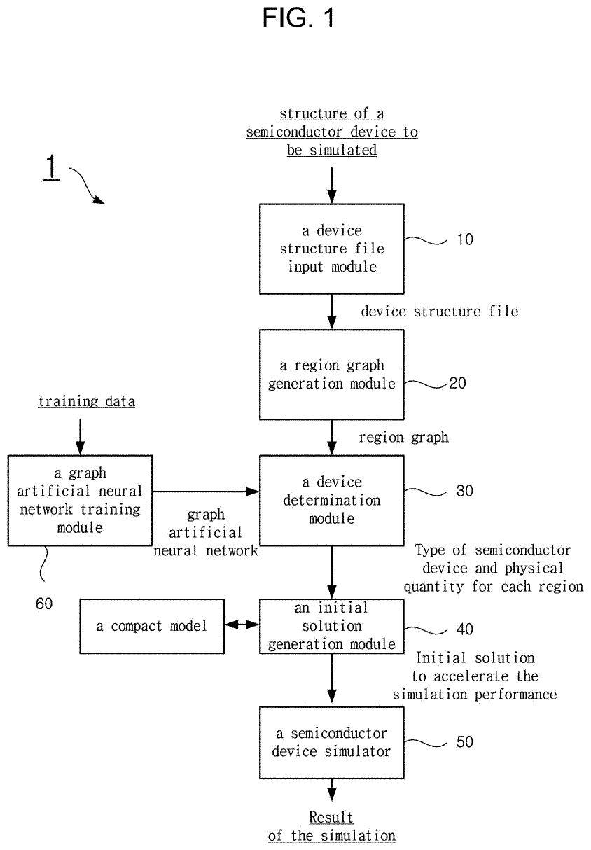

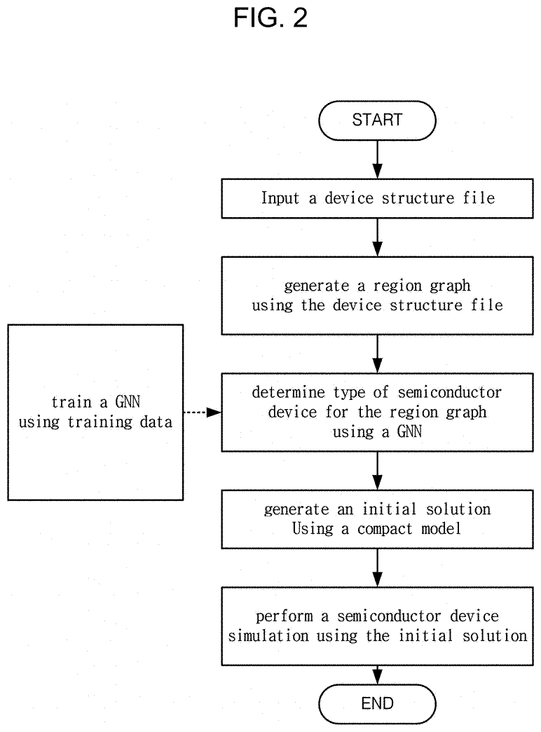

FIG. 1 is a block diagram showing the overall semiconductor device simulation system according to a preferred embodiment of the present invention, and FIG. 2 is a flowchart illustrating a process of simulating a semiconductor device using the semiconductor device simulation system according to the present invention.

Referring to FIG. 1, the semiconductor device simulation system 1 according to the present invention may be implemented by hardware such as a computer and execution of programs installed therein. The semiconductor device simulation system 1 according to the present invention includes a device structure file input module 10, a region graph generation module 20, a device determination module 30, an initial solution generation module 40, and a semiconductor device simulator 50. and a graph artificial neural network training module 60.

In the semiconductor device simulation system according to the present invention having the above configuration, information on the structure of a semiconductor device to be simulated can be directly extracted from the device structure file without user intervention by using a graph artificial neural network. In addition, the semiconductor device simulation system according to the present invention can accelerate the simulation speed by obtaining an approximate initial solution to the semiconductor device structure using a compact model. Hereinafter, the configuration and operation of each of the above-described components will be described in detail.

As described in the background technology of the invention, a device structure file may be generated as a result of geometrically inputting the structure of a semiconductor device into a structure generator according to the prior art, or may be generated as a result of inputting a semiconductor manufacturing process condition into a semiconductor process simulator according to the prior art. Accordingly, the device structure file input module 10 receives the device structure file for the semiconductor device to be simulated from the structure generator or the semiconductor process simulator and provides it to the region graph generation module 20.

In the region graph generating module 20 according to the present invention, a device structure file is input from the device structure file input module, for each region constituting the input device structure file, each region of the device is accurately re-divided based on constituent materials and types of impurities, and a region graph indicating the connection relationship between the re-divided regions is generated and output. Here, the constituent material may be silicon, oxide, or the like, and the impurity type may be one of N-type and P-type.

A region graph is a concept proposed by the present invention, which is a graph showing a connection relationship between regions and terminals constituting a semiconductor device, and indicates nodes representing regions and terminals constituting a semiconductor device and the connection relationship between them. Here, the region represents a connected space made of the same material and the same impurity type. A terminal is one of the components of a semiconductor device and refers to a metal that can apply an electrical signal. These regions and terminals can be unambiguously determined without ambiguity according to the given semiconductor device structure.

They occupy a certain volume in space, and respective regions and terminals face other regions and terminals. Accordingly, when regions and terminals are represented as nodes of the region graph, a connection relationship between them can be expressed as a connection relationship between nodes of the region graph. In this way, a region graph corresponding to a specific semiconductor device structure can be clearly determined without ambiguity. Each node of the region graph made in this way includes feature information. This feature information includes whether the node is a bulk region or a terminal, whether a semiconductor or an insulator, and whether the node is an N-doped region or a P-doped region.

As described above, a typical device structure file has point, region, and terminal information, and each region represents a spatial extent made of one material. However, in order to accurately represent the device structure, the information expressed in the device structure file is not sufficient. For example, in actuality, a case in which a region made of one material is composed of a P-doped region and an N-doped region often occurs in the device structure. In this case, it is preferable for accurate device simulation to divide the regions into different regions according to the type of doped impurities, even though they are made of one material. Therefore, the region graph should accurately classify regions according to constituent materials and types of impurities in consideration of these factors.

Therefore, although the device structure file input to the region graph generation module is already divided into regions, the region divided in the device structure file is different from the region of the region graph. For example, in the device structure file, the entire silicon region in which each part is doped with different impurities may be set as one region, and the boundary surface of each region may be different from the point at which the type of impurity changes.

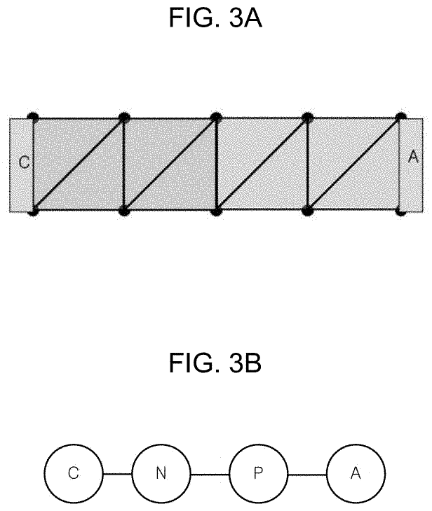

FIG. 3A is a schematic diagram exemplarily illustrating a semiconductor device structure for a PN diode input to generate a device structure file, and FIG. 3B is a region graph the PN diode in the semiconductor device simulation system according to the present invention.

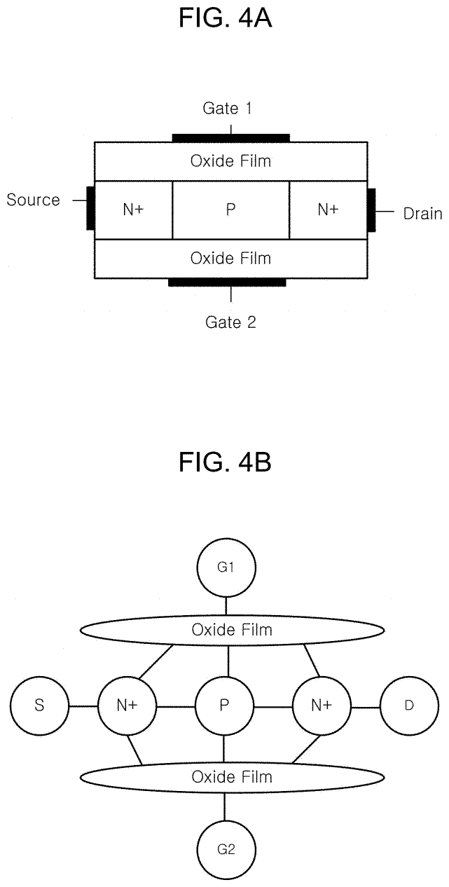

FIG. 4A is a schematic diagram exemplarily showing a semiconductor device structure for a double gate MOSFET input to generate a device structure file, and FIG. 4B is a region graph for the double gate MOSFET in the semiconductor device simulation system according to the present invention.

Referring to FIG. 4A, as an example of a double gate MOSFET, the double gate MOSFET is composed of respective electrodes, regions doped with different impurities, and oxide films. In the device structure file, each region of the device is divided into a tetrahedral shape. The device structure file includes coordinate information of vertices of a tetrahedron constituting each region, and information on constituent materials and types of impurities. Referring to FIG. 4B, the region graph generating module obtains region information from the device structure file and then generates the region graph based on the region information. FIG. 4B is a region graph showing the structure of the semiconductor device of FIG. 4A in the semiconductor device simulation system according to the present invention.

The device determination module 30 classifies the types of semiconductor devices constituting the region graph generated by the region graph generation module using graph neural networks (GNN) supervised in the pre-learning step and outputs the classified the types. The graph artificial neural network is modeled by pre-supervised learning of the graph artificial neural network training module 60.

On the other hand, the graph artificial neural network learning module 60 is characterized in that it trains in a supervised manner the graph artificial neural network model by using the training data composed of a pair of a region graph and a semiconductor device type labeled with respect to the region graph. For example, the training data used in the graph artificial neural network training module may consist of (region graph 1, resistance), (region graph 2, PN junction), (region graph 3, BJT), (region graph 3, MOSFET), etc.

The initial solution generating module 40 is made of a compact model, and information on the type of semiconductor device determined by the device determination module 30 and physical quantity for each region is input. The compact model of the initial solution generating module quickly obtains an approximate solution of the current-voltage characteristic for the physical quantity of each region according to the type of semiconductor device, generates an initial solution by adding the approximate solution for each region, and provides the generated initial solution to the semiconductor device simulator. Since the initial solution generated through this process is very close to the complete solution, it is possible to accelerate the simulation performance of the semiconductor device simulator.

In general, a compact model represents a terminal current according to a terminal voltage with respect to a specific semiconductor device as a simple equation. These compact models are created and distributed by a research group that specializes in developing compact models for each semiconductor device, and the user can design the current-voltage characteristics well by matching the parameters of the compact model well. For example, in the compact model, when information such as the channel length, channel width, oxide film thickness, and doping of the MOSFET is input, the drain saturation current (ID) according to the gate voltage can be calculated as shown in the following equation.

$${I}_{D} = \frac{1}{2} {μ}_{n} {C}_{ox} \frac{W}{L} {( {V}_{GS} - {V}_{TH} )}^{2}$$

Of course, the above example is a very simple case, but even in a more complex actual compact model, the complexity of the equation only increases, and a mesh is not introduced as in the case of semiconductor device simulation. Therefore, it is possible to calculate the terminal current much more efficiently using the compact model. As a result, by using the compact model, it is possible to analyze a large circuit consisting of a large number of elements without unreasonableness.

Meanwhile, the semiconductor device simulator 50 obtains a complete solution by performing a simulation using the initial solution provided from the compact model and finally outputs the complete solution. The semiconductor device simulator according to the present invention is the same as the conventional semiconductor device simulator, but the present invention can accelerate the simulation speed by finding the initial solution as the closest value to the complete solution and providing it to the semiconductor device simulator.

In the above, the present invention has been mainly described with respect to preferred embodiments thereof, but this is merely an example and does not limit the present invention. Those of ordinary skill in the art to which the present invention pertains will appreciate that various modifications and applications not exemplified above are possible without departing from the essential features of the present invention. And, the differences related to these modifications and applications should be interpreted as being included in the scope of the present invention defined in the appended claims.

What is claimed is:

1. A semiconductor device simulation system comprising:
a region graph generation module for generating a region graph using a device structure file of a semiconductor device to be simulated;
a device determination module for determining a type of semiconductor device for the region graph generated by the region graph generating module using a pre-trained graph artificial neural network;
an initial solution generating module for generating an initial solution for a device structure corresponding to the type of semiconductor device determined by the device discrimination module; and,
a semiconductor device simulator for performing semiconductor device simulation using the initial solution generated by the initial solution generating module,
wherein the speed of performing semiconductor device simulation is accelerated by providing an approximate initial solution to the device structure to a semiconductor device simulator.

2. The semiconductor device simulation system of claim 1, wherein the device structure file is generated by a structure generator program or a semiconductor process simulation program.

3. The semiconductor device simulation system of claim 1, wherein the region graph generating module re-divides regions of the device structure file based on constituent material and impurity type,
expresses re-divided region and terminals of the device structure file as nodes, respectively,
expresses connection relationships between the nodes, and
generates a region graph expressed by the nodes and the connection relationships.

4. The semiconductor device simulation system of claim 1, wherein the semiconductor device simulation system further comprises a graph artificial neural network training module,
the graph artificial neural network training module trains in a supervised manner and models a graph artificial neural network using training data consisting of a pair of a region graph and a type of semiconductor device corresponding to the region graph, and
the device determination module determines the type of semiconductor device for the region graph using the graph artificial neural network trained in a supervised manner by the graph artificial neural network training module.

5. The semiconductor device simulation system of claim 1, wherein the initial solution generating module comprises a compact model that provides a current-voltage characteristic equation for each semiconductor device structure, and
the initial solution generating module obtains a voltage characteristic equation for a semiconductor device structure corresponding to the type of semiconductor device determined by the device determination module using the compact model and sets the obtained voltage characteristic equation as an initial solution for the semiconductor device structure.

6. The semiconductor device simulation system of claim 5, wherein,
the initial solution generating module inputs information on the type of semiconductor device determined by the device determination module and the physical quantity for each region, and
wherein the compact model obtains an approximate solution of the current-voltage characteristic for the physical quantity of each region according to the type of semiconductor device input,
generates an initial solution by summing approximate solutions for each region, and
provides the generated initial solution to the semiconductor device simulator.

7. A semiconductor device simulation method comprising the following steps:
(a) generating a region graph using a device structure file of a semiconductor device to be simulated;
(b) determining the type of semiconductor device for the region graph using a graph artificial neural network;
(c) generating an initial solution for a device structure corresponding to the determined type of semiconductor device; and,
(d) performing a semiconductor device simulation using the generated initial solution,
wherein the semiconductor device simulation is accelerated.

8. The semiconductor device simulation method of claim 7, wherein the device structure file is generated by a structure generator program or a semiconductor process simulation program.

9. The semiconductor device simulation method of claim 7, wherein the step (a) comprises:
re-dividing regions of the device structure file based on constituent material and impurity type,
expressing the re-divided regions and terminals of the device structure file as nodes respectively,
expressing connection relationships between the nodes, and
generating a region graph expressed by the nodes and the connection relationships.

10. The semiconductor device simulation method of claim 7, further comprising: (e) training a graph artificial neural network, wherein the graph artificial neural network is trained in a supervised manner and modeled using training data consisting of a pair of a region graph and a type of semiconductor device corresponding to the region graph, and in the step (b), the type of semiconductor device for the region graph is determined using the graph artificial neural network trained in a supervised manner.

11. The semiconductor device simulation method of claim 7, wherein the step (c) prepares a compact model that provides a current-voltage characteristic equation for each semiconductor device structure, and
obtains a voltage characteristic equation for a semiconductor device structure corresponding to the type of semiconductor device determined in step (b) using the compact model, and
set an initial solution for the structure using the obtained voltage characteristic equation.
